(19) United States
(12) Patent Application Publication
(10) Pub. No.: US 2018/0375805 A1
(43) Pub. Date: Dec. 27, 2018

(54) Collecting Information in a Messaging System

(71) Applicant: Microsoft Technology Licensing, LLC, Redmond, WA (US)

(72) Inventors: Manish Sethi, Hyderabad (IN); Amod Anil Agashe, Hyderabad (IN); Udit Arora, Hyderabad (IN); Deepak Kumar Pratinidhi, Hyderabad (IN); Rajiv Kumar, Hyderabad (IN); Subodh Kumar, Hyderabad (IN); Ravi Birhman, Hyderabad (IN); Abhijit Kumar Bairagi, Hyderabad (IN); Gopalakrishnan Venkateswaran, Hyderabad (IN); Rahul Bhuptani, Hyderabad (IN); Abhishek Agrawal, Hyderabad (IN); Utsab Bose, Hyderabad (IN)

(73) Assignee: Microsoft Technology Licensing, LLC, Redmond, WA (US)

(21) Appl. No.: 15/695,675

(22) Filed: Sep. 5, 2017

(30) Foreign Application Priority Data
Jun. 23, 2017 (IN) 201741022186

(51) Int. Cl. H04L 12/58; G06F 17/30

(52) U.S. Cl. CPC H04L 51/046; G06F 17/30035; H04L 51/16

(57) ABSTRACT

A database is populated with information provided by users of the messaging system, the messaging system for effecting instant messaging communication sessions via a network. Initial information held in the database itself is used to generate a plurality of information requests. Each of the information requests is sent to a recipient user via the network in an instant messaging communication session affected by the messaging system. Fields of the database are assigned to the recipient uses or to groups of the recipient users, and their responses to the information requests are used to populate those fields.

### RELATED APPLICATIONS

This application claims priority under 35 USC 119 or 365 to India Application No. 201741022186 filed Jun. 23, 2017, the disclosure of which is hereby incorporated by reference in its entirety.

### TECHNICAL FIELD

The present invention pertains to the use of a messaging system to collect information from users participating in one or more instant messaging communication sessions in order to populate a database.

### BACKGROUND

A messaging system allows users of the messaging system to exchange (instant) messages with other users of the messaging system in an instant messaging communication session. In order to use the messaging system, each user operates a user device with an instance of a messaging application (app) executed on that device. The messages are primarily text-based, but can also comprise rich content such as images, videos, documents, audio etc. This is referred to as instant messaging. The messaging takes place in real time, in that there is typically only a short delay (e.g. about two seconds or less) between a user sending a message and it being received by its intended recipient(s). The messages are transmitted and received between users via a network, for example a packet-based network such as the Internet, in the instant messaging communication session, which is effected by the messaging system, and in which the users are engaged. Other rich functionality, such as collaborative documents editing, poll creation, survey creations etc. may also be provided within the instant messaging communication session.

Within the messaging system, users may be able to create messaging groups. Multiple users, e.g. more than two users, may be participants in a messaging group. The participant's messaging accounts may be associated with the messaging group, which provides a convenient means by which those users can communicate with each other using a messaging service of the messaging system. For example, the messaging service may comprise a messaging server which relays messages between users in the group, or a look up server which allows network addresses of the users to be obtained so that messages can be sent between them directly etc. An instant messaging session can be conducted between all users in a group, and it may be possible to conduct further instant messaging communication sessions with sub-groups of a larger group.

### SUMMARY

A first aspect of the present invention is directed to a computer-implemented method of populating a database with information provided by users of a messaging system, the messaging system for effecting instant messaging communication sessions in which users of the message system engage by sending and receiving messages via a network of the messaging system, the method comprising implementing, by an information manager, the following steps: in response to an instruction received from an initiating one of the users, retrieving from the database initial information held in the database; generating a plurality of information requests based on the initial information retrieved from the database; sending each of the information requests to a recipient user via the network in an instant messaging communication session effected by the messaging system; receiving a response to each of the information requests, wherein that response conveys at least one piece of information provided by the recipient user to which that message was sent; assigning each of a plurality of fields of the database to one of the recipient users or to a group of the recipient users; and populating each of the database fields with one of the pieces of information provided by the recipient user to which it is assigned or one of the group of recipient users to which it is assigned.

The generated requests request, from the recipient users, pieces of information to be entered in the database field assigned to those users or their groups. Generating those requests using initial information that is retrieved from the database itself provides a convenient and self-contained mechanism for requesting and receiving information. The initial information can be entered in the database by the initiating user to indicate how he wishes the rest of the database to be populated. The database can for example be an electronic spreadsheet. The initiating user can enter the initial information into the spreadsheet to indicate desired structure and content for the spreadsheet, and the information manager uses this to automatically request the necessary information from the recipient users and uses that information to automatically populate the spreadsheet in the manner indicated by the initiating user via the initial information entered in the spreadsheet.

In embodiments, each of the information requests may comprise an identifier of a requested information type derived from the initial information by the information manager.

The initial information may comprise at least one column header of the electronic spreadsheet from which the identifier of the requested information type is derived.

Each of the information requests may be in the form of a survey having a series of questions derived from the initial information to be rendered at a user device operated by its recipient user.

The initial information may comprise multiple column headers of the spreadsheet and each of the questions may be derived from one of the column headers.

The plurality of database fields may be assigned to the recipient users or groups based on the responses received to the information requests.

The plurality of database fields may be pre-assigned to the recipient users or groups before the responses are received.

The fields may be pre-assigned by the information manager using the initial information in the database.

Each of the information requests may comprise structural data for rendering, at a user device operated by its recipient user, a representation of a set of the database fields pre-assigned to its recipient user or a group its recipient user is a member of the structural data denoting a structure of that set of database fields within the database, wherein at least two of the recipient users or groups are pre-assigned different sets of database fields.

The information manager may use a first part of the initial information to generate a first of the information requests sent to a first of the recipient users, and a second part of the initial information to generate a second of the information requests sent to a second of the recipient users, whereby the first and second recipient users receive different information requests.

The information manager may assign a first set of fields of the database to the first recipient user or to a group the first recipient user is a member of, the first information request being generated based on that assignment, and assign a second set of fields of the database to the second recipient user or to a group the second recipient user is a member of, the second information request being generated based on that assignment, whereby the first and second information requests are generated from different sets of database fields.

The first part of the initial information may be retrieved from at least one of the first set of database fields and at least another of the first set of database fields may be populated with the piece of information provided by the first recipient user, and the second part of the initial information may be retrieved from at least one of the second set of database fields and at least another of the second set of database fields may be populated with the piece of information provided by the second recipient user.

The first information request may comprise first structural data denoting a structure of the first set of database fields within the database for rendering a representation of the first set of database fields at a user device operated by the first recipient user, and the second information request may comprise second structural data denoting a structure of the second set of database fields within the database for rendering a representation of the second set of database fields at a user device operated by the second recipient user.

The information manager may identify at least one of the recipient users or groups automatically using the initial information in the database.

A second aspect of the invention is directed to an information manager for populating a database with information provided by users of a messaging system, the messaging system for effecting instant messaging communication sessions in which users of the message system engage by sending and receiving messages via a network of the messaging system, the information manager comprising: a network interface configured to connect to the network; at least one processor; and electronic storage coupled to the at least one processor and configured to hold computer-readable instructions, which are configured, when executed on the at least one processor, to implement the steps of the first aspect or any embodiment thereof.

A third aspect of the invention is directed to a computer program product comprising computer-readable instruction stored on a computer-readable storage medium and configured, when executed, to implement the steps of the first aspect or any embodiment thereof.

### BRIEF DESCRIPTION OF FIGURES

For a better understanding of the present invention, and to show how embodiments of the same may be carried into effect, reference is made to the following figures in which:

FIG. 1 shows a schematic block diagram of a messaging system;

FIG. 1A shows a schematic block diagram of a user device;

FIG. 2 shows a schematic functional block diagram for the messaging system;

FIG. 3A shows a how a document editor for creating and editing a spreadsheet may be implemented locally at a user device;

FIG. 3B shows how a document editor may be implemented remotely at a server;

FIG. 4 shows a schematic illustration of a messaging interface displayed on a mobile device;

FIG. 5 shows a flowchart for a method of collecting information to populate a database from users of a messaging system;

FIG. 6 shows an example schematic user interface provided by a document editor for editing a spreadsheet;

FIG. 7A shows an example of how a user interface provided by a document editor may be adapted to allow information to be requested from users of a messaging system;

FIGS. 7B, 7C, 7D, 7E, and 7F show how an information request can be rendered at a recipient user's mobile device as a survey;

FIGS. 7G and 7H illustrate one example of how a spreadsheet can be updated with information collected from users of a messaging system over time automatically by a database manager;

FIGS. 8A and 8B show one example of how different spreadsheet cells can be pre-assigned to different user groups for the purposes of collecting information to populate those spreadsheet cells;

FIGS. 8C, 8D, 8E, and 8F show examples of how information can be collected from users who have been assigned certain spreadsheet cells in order to populate those spreadsheet cells with information from those users; and

FIG. 8G shows how spreadsheet cells assigned to particular users or groups can be automatically updated with information provided by those users or users in those groups.

### DETAILED DESCRIPTION OF EXAMPLE EMBODIMENTS

Embodiments of the invention are described below in relation to a database in the form an electronic spreadsheet, such as an Excel document. In this context, individual cells of the spreadsheet constitute database fields.

Electronic spreadsheets, such as Excel documents, are used extensively for storing and processing data by users. An electronic spreadsheet can be created and edited using a spreadsheet application, such as Excel, which can be a locally executed spreadsheet application or a Web application that is accessed via the Internet, for example.

The described embodiments leverage the power and reach of spreadsheet applications to integrate with a messaging app to help users seamlessly collect data from their network, using instant messaging functions.

An initiating user operates a user device, which he uses to create an electronic spreadsheet and populate it with some initial information, via a user input device of the user device. This initial information in the spreadsheet indicates what type of information the initiating user wants other users to provide (recipient users). For example, the initiating user may add a title (header) to a column of the spreadsheet to indicate a type of data to be entered in that column. It is convenient for the initiating user to enter this information in the actual spreadsheet to be populated, rather than having to provide it through a separate channel. When instructed by the initiating user, an information manager—also referred to as a database manager herein extracts this initial information from the spreadsheet and uses it to generate information requests that are sent to the recipient users. The recipient users can be identified by the database manager automatically using the initial information in the spreadsheet itself, or information provided by the initiating user as part of the instruction to the database manager. Each of the information requests is sent to its recipient user in an instant messaging communication session, also referred to herein as a “chat” or, equivalently, a “conversation”. The requests may all be sent in the same chat in which the recipient users are participating, or different information requests may be sent in different chats in which different recipient users are participating. Each recipient user can respond to the information request within the chat in which the request is sent, in order to provide one or more pieces of requested information. Cells of the spreadsheet are assigned to individual users, particular groups of users, or a combination of both. A cell assigned to a particular user or group of users is used by the database manager to hold information provided by that user or group. When any recipient user provides a piece of information in a chat, that piece of information will only ever be entered in a cell assigned to that user or to a group that user is a member of. Cells can be assigned to the recipient users before or after the information requests are sent, and may be assigned autonomously by the database manager (possibly using the initial information in the spreadsheet) or as specified by the initiating user in his instruction to the database manager.

The information request can be in the form of a “survey” wherein a series of questions is presented to the recipient user and his answers are used to populate the cells assigned to him or his group. Alternatively, a version of the cell(s) assigned to him or his group, corresponding to a limited portion of the spreadsheet, may be rendered at his device so he can edit those cells (and only these cells) directly.

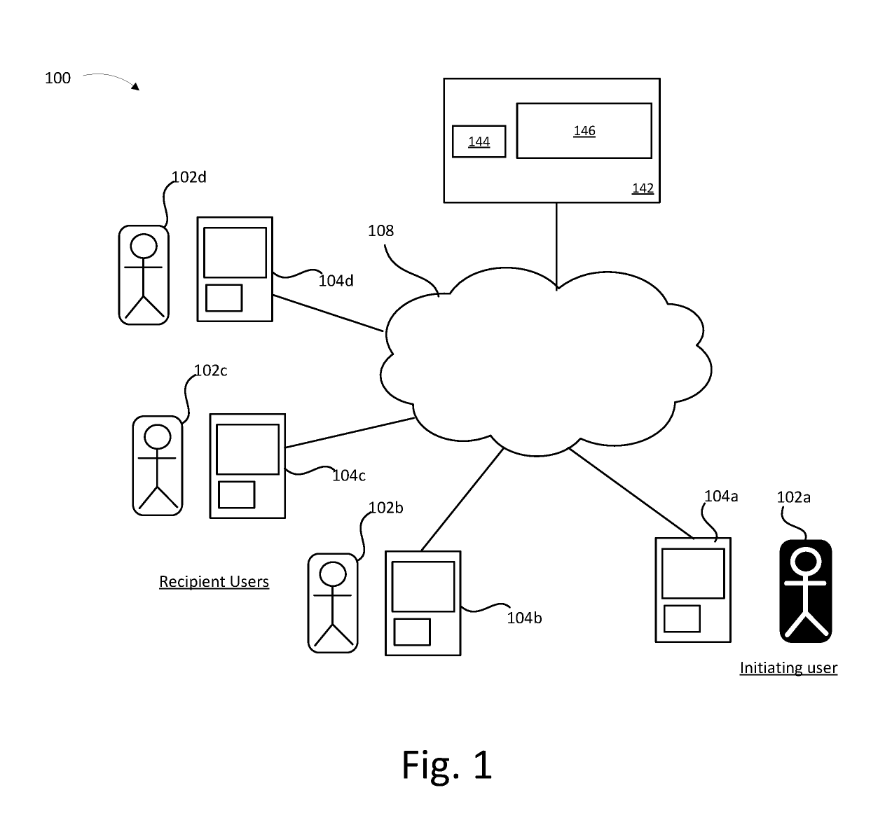

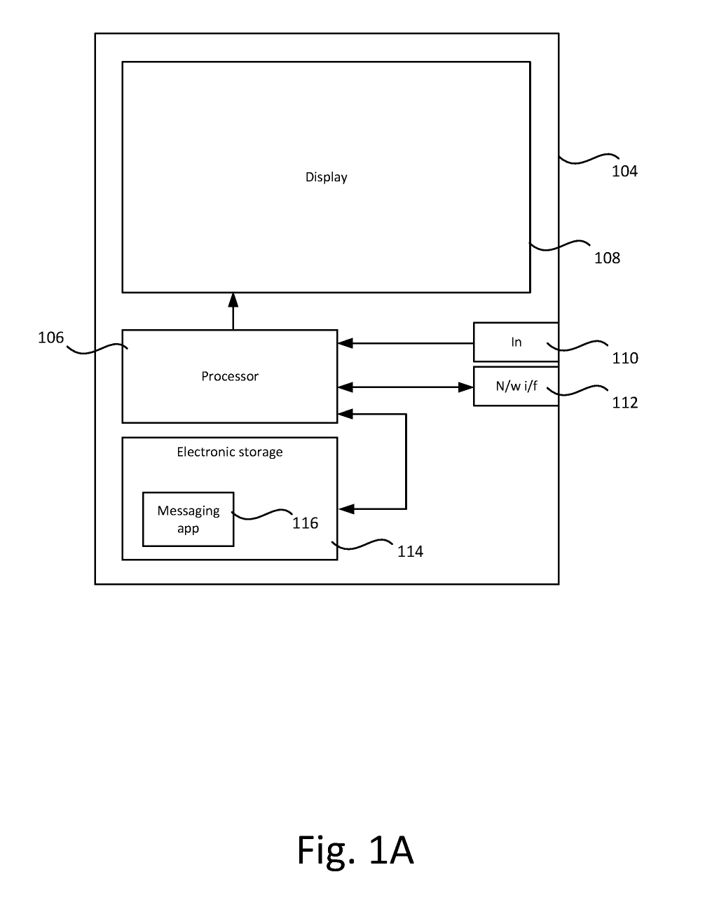

FIG. 1 shows a highly schematic block diagram of a messaging system 100 comprising a backend system 142 and a plurality of user devices 104a-d operated by users 102a-d respectively. The backend system 142 and user devices 104a-d are shown connected to a network 108, which is a packet-based computer network such as the Internet.

FIG. 1A shows a schematic block diagram of an example user device 104, which is shown to comprise a processor 106 (such as a Central Processing Unit (CPU) or set of CPUs/CPU cores) and, connected to the processor, a display 108, which can be controlled to display visual information to a user of the device 104; an input device 110 for receiving user input from the user, such as touchscreen, mouse, trackpad, gesture or voice recognition device, etc.; a network interface 112 via which the user device 104 can connect to the network 108, and electronic storage 114. The electronic storage 114 is shown holding a messaging application 116 for execution on the processor 106, via which the user of the user device 104 can access services provided by the messaging system 100. To execute the messaging application 116, the processor 106 fetches instructions of the messaging application 116 and carries out functions according to those instructions in order to implement the functionality of the messaging application 116. In particular, the messaging application 116 has instructions that when executed on the processor 106 cause the user device 104 to connect via the network 108 to the backend system 142, thereby allowing the user 102 to access services provided by that system from his user device 104. The user device 104 can take a number of forms, such as a smartphone, tablet, personal computer etc.

As will be appreciated, FIG. 1A is highly schematic, and all description pertaining to the user device 104 applies equally to the user devices 104a-d in FIG. 1 even though they may differ in their specifics.

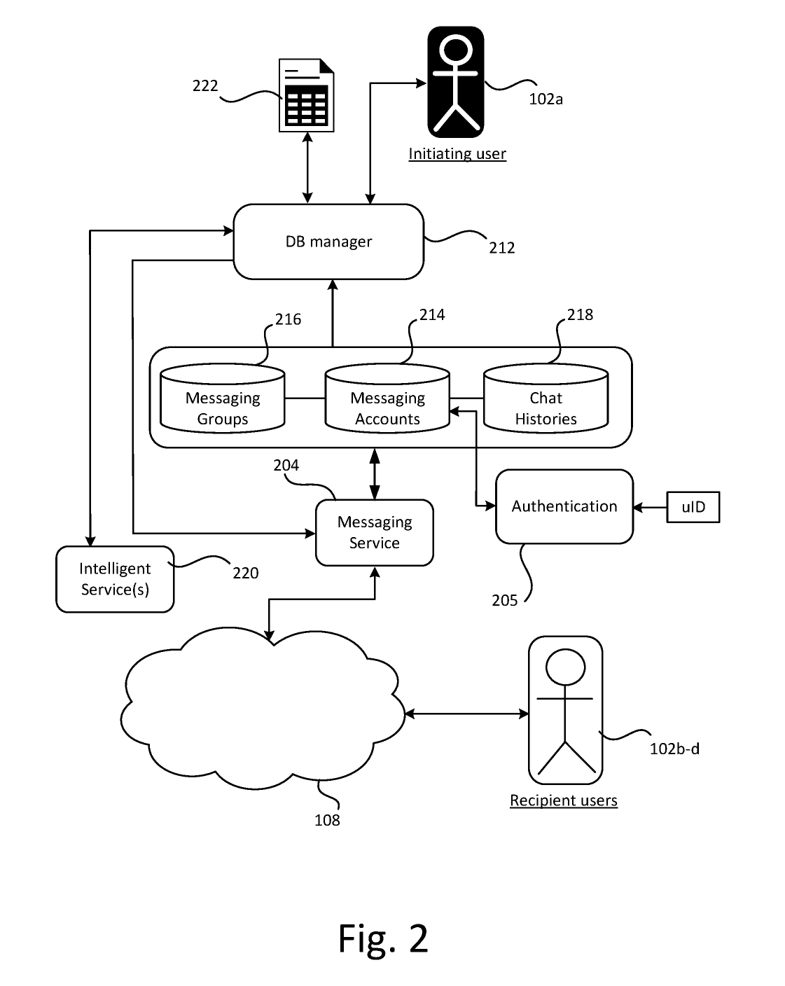

Returning to FIG. 1, the backend system 142 is shown to comprise at least one processor 144, such as a CPU or CPUs/CPU cores, and backend computer storage 146 accessible to the at least one processor 144. The at least one processor 144 is configured to execute message system code (not shown) stored in the backend computer storage 146 in order to implement the functionality of the backend system 142 that is described below. In particular, the messaging code implements, when executed, a group messaging service (204, FIG. 2) and an authentication function (205, FIG. 2). The backend system 142 can for example be implemented on a cloud platform. Cloud computing is well known so further details are not discussed herein. Alternatively, at least part of the functionality of the backend system 142 described herein could instead be implemented in a peer-to-peer fashion, wherein the user devices themselves cooperate to provide this functionality.

With reference to FIG. 2, within the messaging system 100, user accounts 214 are created and stored in the backend computer storage 146. User accounts within the messaging system 100 are referred to as messaging accounts. Each messaging account 214 comprises user data of its user, such as a user credential(s) and other information pertaining to the user in the context of the messaging system 100. In particular, each messaging account 214 comprises a user identifier (ID)—denoted uID in the figures—which is used to identify the user of that account within the messaging system 100, the user ID is a mobile number in the following examples. In other words, within the messaging system 100, each user has a primary identity, which is their mobile number uID in this example, and which is used to authenticate the user by the authentication function 205. By successfully authenticating himself against one of the messaging accounts 214, via the authentication function 205, a user becomes an authorised (i.e. authenticated) user of that account.

The messaging service 204 of the messaging system 100 is an instant messaging service that allows authorized users of the messaging accounts 214 to transmit instant messages to and receive instant messages from other authorised users of the messaging system. The messaging service 204 also allows those users to create messaging groups 216 (user groups). Information about each messaging group 216, such as a group identifier (grpID) and information about the users participating in that messaging group, is stored in the backend computer storage 146. The messaging accounts 214 of users participating in a messaging group are associated with the messaging group (that is, with the group ID of that messaging group) in the backend computer storage 146. Based on this group information and the information in the associated messaging accounts 214, the messaging service 204 allows the group participants to exchange instant messages within the messaging group via the network 108. That is, to engage in a chat with any of their groups. For example, the messages may be relayed between the participants by the messaging service—for example, via one or more message relay servers or other message relay nodes of the messaging system 100—or the messaging service 204 may provide network address information to allow the participants to exchange the messages with each other directly, in a peer-to-peer fashion. A variety of instant messaging protocols are in use today supporting a range of instant messaging services from different providers. The general principals of instant messaging are well known and are therefore not described in further detail.

However the messaging service 204 is implemented, the user identifiers uID are used as a basis for the exchange of messages in each messaging group, for example by identifying user devices 104 associated with the user identifiers uID of the users in the messaging group as recipient devices for messages in the group.

The messaging service 204 stores copies of messages exchanged in each chat in the backend storage 146 (chat histories, 218), so that they can be retrieved by users participating in those chats at any time.

The messaging service 204 can also provide enhanced (rich) communication functions within chats, such as the communication of interactive content (polls, surveys, meeting invites, job assignments etc.), rich content (audio data, image data, file sharing etc.). Each type of interactive content is also referred to herein as a “card”.

FIG. 2 also shows a database (DB) manager 212 (information manager) having access to a database in the form of an electronic spreadsheet 222 created by an initiating user (user 102a), who is an author of the spreadsheet 222. An electronic spreadsheet 222 is one example of a database that can be embodied as a file. The DB manager 212 populates the spreadsheet 222 using information collected from multiple recipient users (users 102b-d) via the messaging system 100 in the manner outlined above and described in further detail below. Although three recipient users 102b-d are shown in FIG. 1, this is purely exemplary and there can be any number of recipient users.

The database manager 212 is a computer system which can be implemented in a localised fashion, at a single computing device, or in a distributed fashion where different parts of that functionality are implemented at different co-operating computer devices. It can be implemented locally in the sense that it is embodied in the initiating user's device 104a or it can be implemented remotely for example as part of the back end system 142. The functionality of the database manager 212 is implemented in software, for example as code executed on the processor of the initiating user's device (104a) or the processor 144 of the back end system 142.

FIG. 2 also shows, by way of example, how one or more intelligent services 220 can be provided by the back end 142, which the database manager 212 can connect to request semantic analysis of information entered in the spreadsheet 222 by the initiating user 102a or responses referred by the recipient user 102b-d.

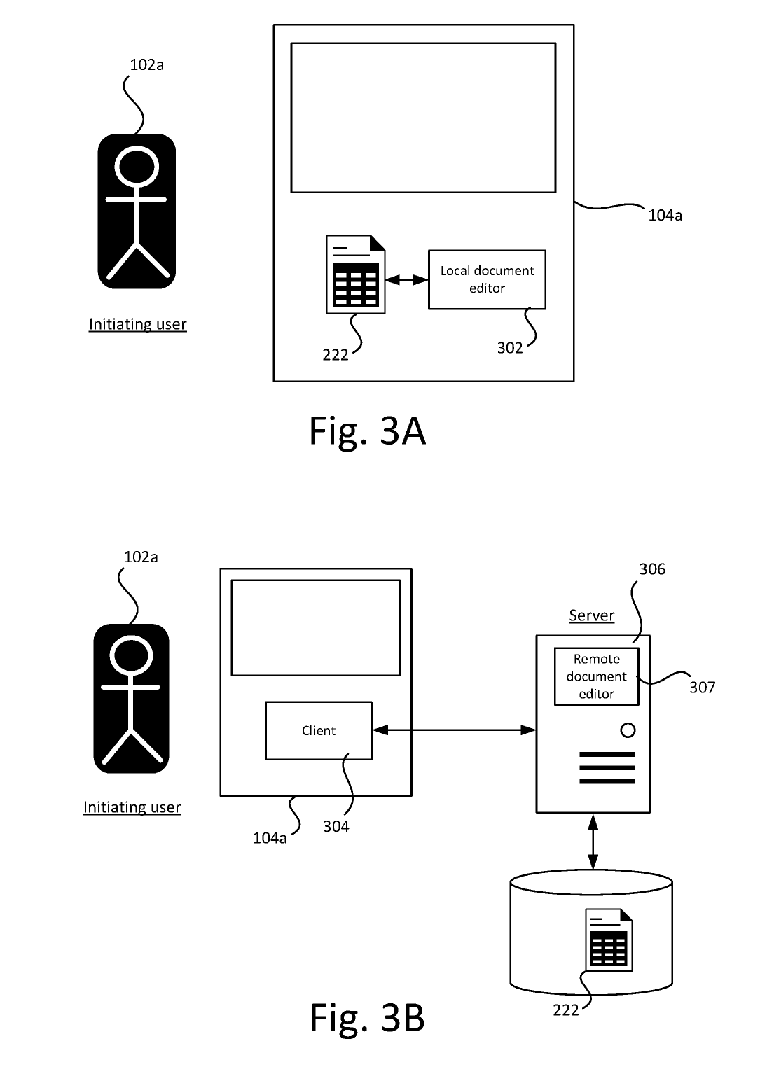

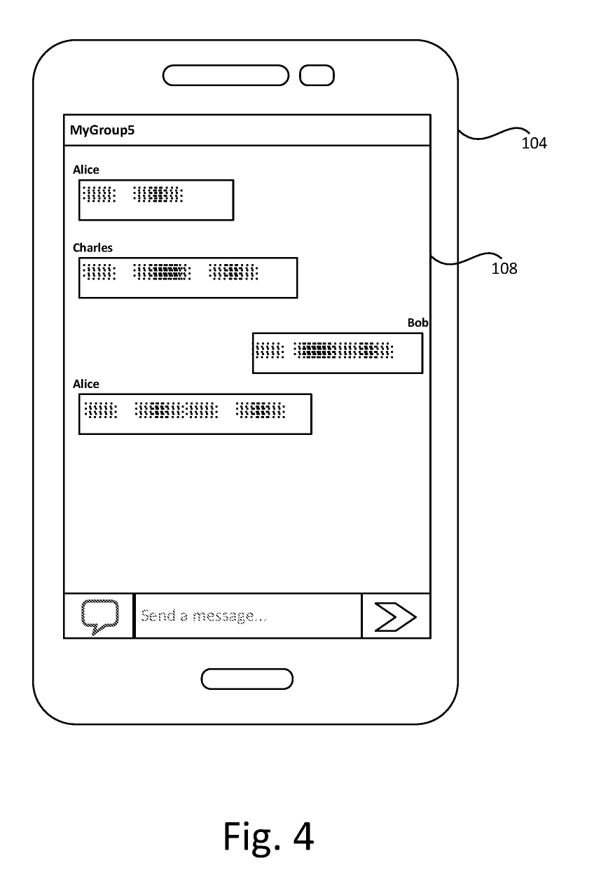

With reference to FIG. 3A, the initiating user 102a can for example create and edit the spreadsheet 222 using a local document editor 302 executed on his device 104a, such as Excel. In this case, the spreadsheet 222 is stored locally at the user device 104a. Alternatively, with reference to FIG. 3B, the spreadsheet 222 can be created and edited remotely, in an “online” document editing context. In this case the user device 104a executes a client application 304, such as a Web browser, which communicates with a document server 306 via the network 108. A remote document editor 307 executed at the document server 306 creates and modifies the spreadsheet 222, which is stored at the server 306, according to instructions received from the initiating user 102a via the client 304. Examples of online editing tools for spreadsheets include Excel Online/OneDrive, Google document editor etc. Where the description refers to a “document editor” below, this can be a local document editor as in FIG. 3A or a remote document editor as in FIG. 3B depending on the context.

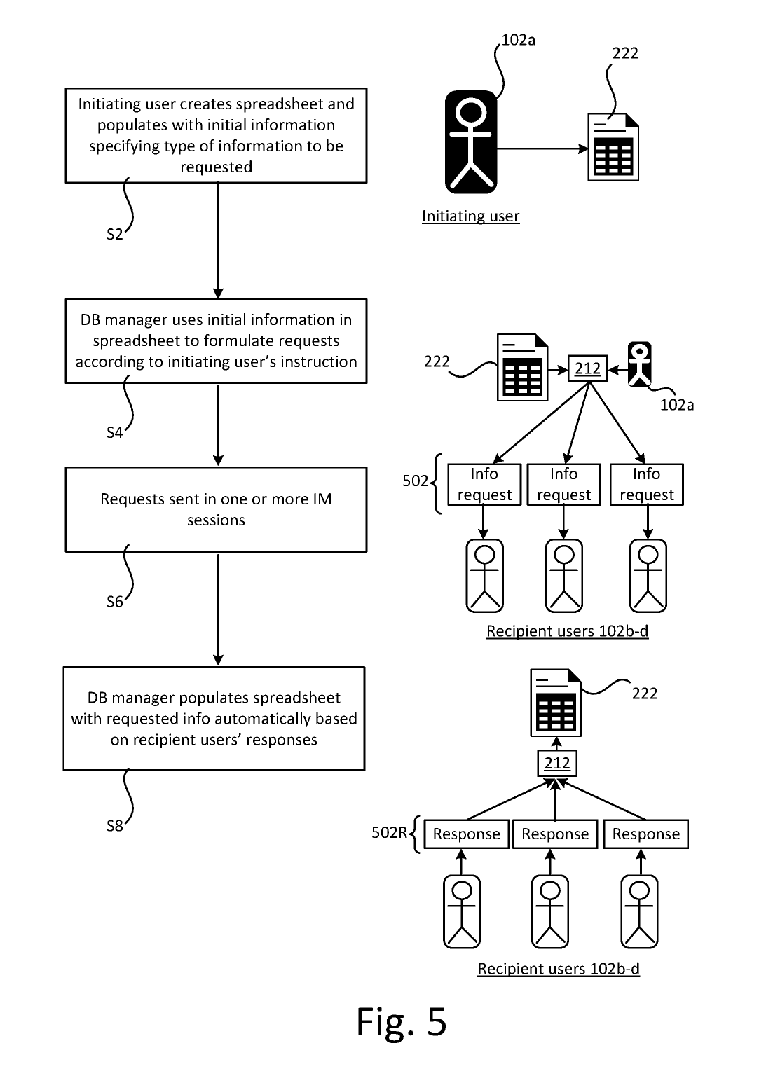

FIG. 4 shows an example of a user interface rendered on the display 108 of the user device 104, which a mobile device in this example. The user interface (UI) shows a chat between members of a particular messaging group. Instant messages transmitted and received between the members of that group are shown on the UI as a sequence of messages ordered according to time. The user's own messages are displayed towards one side of the display 108 whereas messages from other users are displayed towards the opposite side of the display 108. In this manner, the UI provides a messaging interface for the group in question. As described below, it is this messaging interface that is used as a means for collecting information from the recipient users in order to populate the spreadsheet 222.

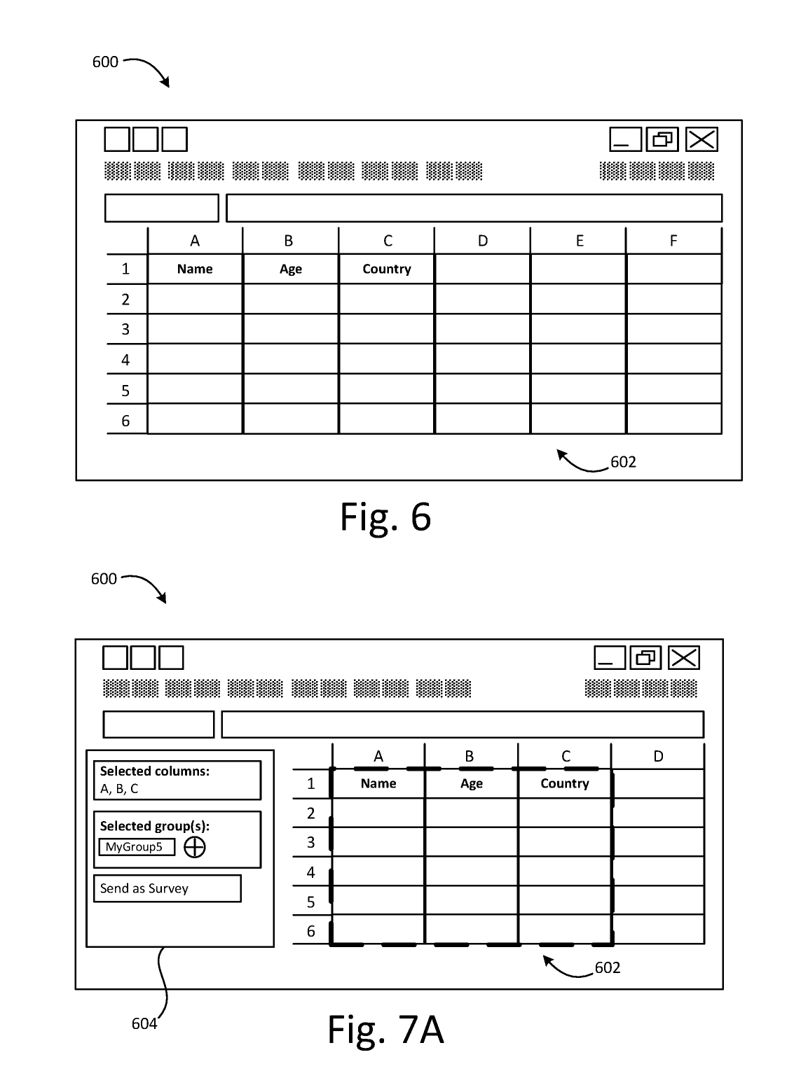

FIG. 5 shows, on the left hand side, a flow chart for a method of populating the spreadsheet 222 with information provided by users of the messaging system 100 and, on the right hand side, a graphical illustration of the method steps.

At step S2, the initiating user 102a creates the spreadsheet 222 and populates it with initial information. The initial information specifies the type or types of information that the initiating user 102a wants other users to provide in order to complete the spreadsheet 222. A simple case is where the initiating user 102a enters column headers into the spreadsheet 222 in order to identify the type of information he wants collected for each column. The initiator user 102a may also have the option of entering additional information into the spreadsheet 222 at this stage, for example, to provide more targeted information collection. Examples of this are described later.

At step S4, the database manager 212 uses the initial information as entered in the spreadsheet 222 at step S2 to formulate information requests 502 to be sent to the recipient users 102b-d. These information requests 502 are generated according to an instruction from the initiating user 102a. The instruction can for example can be provided by the instruction user 102a selecting one or more UI options provided by the database manager 212 in order to specify or confirm which users the requests 502 should be sent to, and in some cases to specify which parts of the initial information in the spreadsheet 222 should be used to formulate which of the requests 502. In some implementations, the database manager 212 can use results of a semantic analysis performed on the initial information by the intelligent service(s) 220.

At step S6, each of the information requests 502 is sent to its intended recipient user in an instant messaging communication session (i.e. chat). The requests 502 can be sent in a single chat in which all of the intended recipient users are participating, or different requests 502 can be sent in different chats in which different recipient users are participating. Thus the requests 502 can be sent in one or more chats. The recipient users 102b-d receive these and each recipient user responds to the information request he has received in the chat in which it was sent. This may utilise one or more of the enhanced communication functions provided by the messaging service 204 as described later in various examples.

At step S8 the database manager 212 receives the responses 502R from the recipient users 102b-d and uses those responses 502R to populate the spreadsheet 222 automatically with the information conveyed in the responses 502R. The information provided by each recipient user is entered into cells of the spreadsheet 222 that are either assigned to (i.e. reserved for) that user or which are reserved for a group that user is a member of. For example, the information request 502 can be sent to all users in a particular group and each user in that group may be assigned a row or rows of the spreadsheet that are each reserved for holding a respective piece of information provided by that user. Another example is where the information requests 502 are sent to recipient users in multiple groups, in multiple chats, and each user group is assigned a row or rows of the spreadsheet which is reserved for holding information provided by the users in that group (where any user in a given group can provide information to be entered in cells reserved for that group).

Various example implementations will now be described.

### EXAMPLE 1

The initiating user 102a uses a document editor to create an empty table (e.g. Excel Table) in the spreadsheet 222, with only table column titles (headers), and which might have table formulas in one or more columns. Via a user interface of the document editor itself, the initiating user 102a can connect to the messaging service 204 and select the table to send to one of his groups in the messaging system 100.

The initiating user 102a might choose to send only certain columns and may, for example, exclude any columns containing formulas. Columns containing formulas may be identified automatically by the database manager 212 and excluded by default, so that the user does not have to indicate them manually, but the user may be able to adapt the default selections.

The database manager 212 converts the selected part of the selected table into a survey, with table columns being converted into survey questions. Each question is derived from one of the column headers using that column header as an identifier of the type of information to be requested. The survey is circulated within the group via a group chat, exploiting the rich functionality of the messaging service 204.

Users in the group can then work in a familiar survey environment and answer the questions derived from the column titles. At a later point, the initiating user 102a could access the spreadsheet 222 using the document editor, and choose to fetch the data back from the survey into the table. In response, the document editor connects to the messaging service 204, fetches the group responses from the survey, and uses these to fill-in the table. Any column with formulas will be auto computed. Alternatively, the document editor can refresh the spreadsheet 222 automatically without requiring manual refreshes. For example, the spreadsheet 222 can be updated automatically as the recipient users respond, without the user having to refresh the document, by pushing updates to the document editor as responses are received from the recipient users.

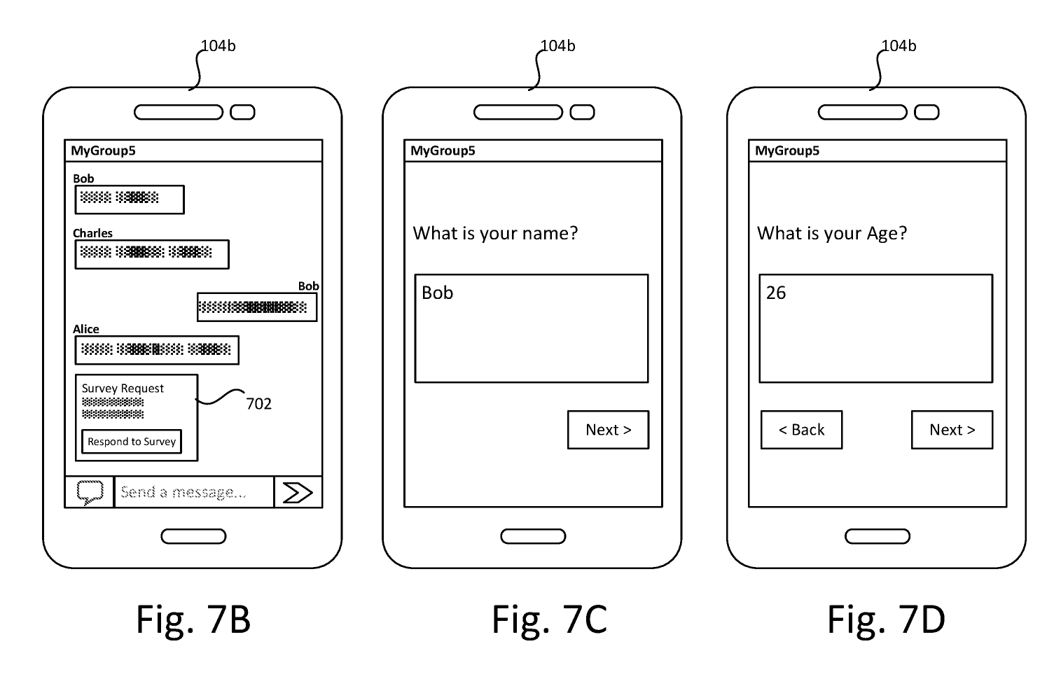

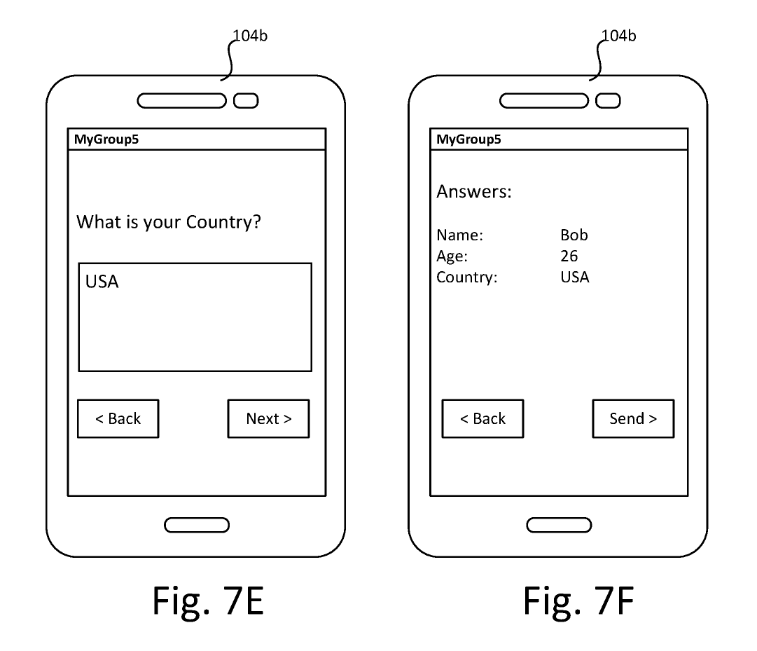

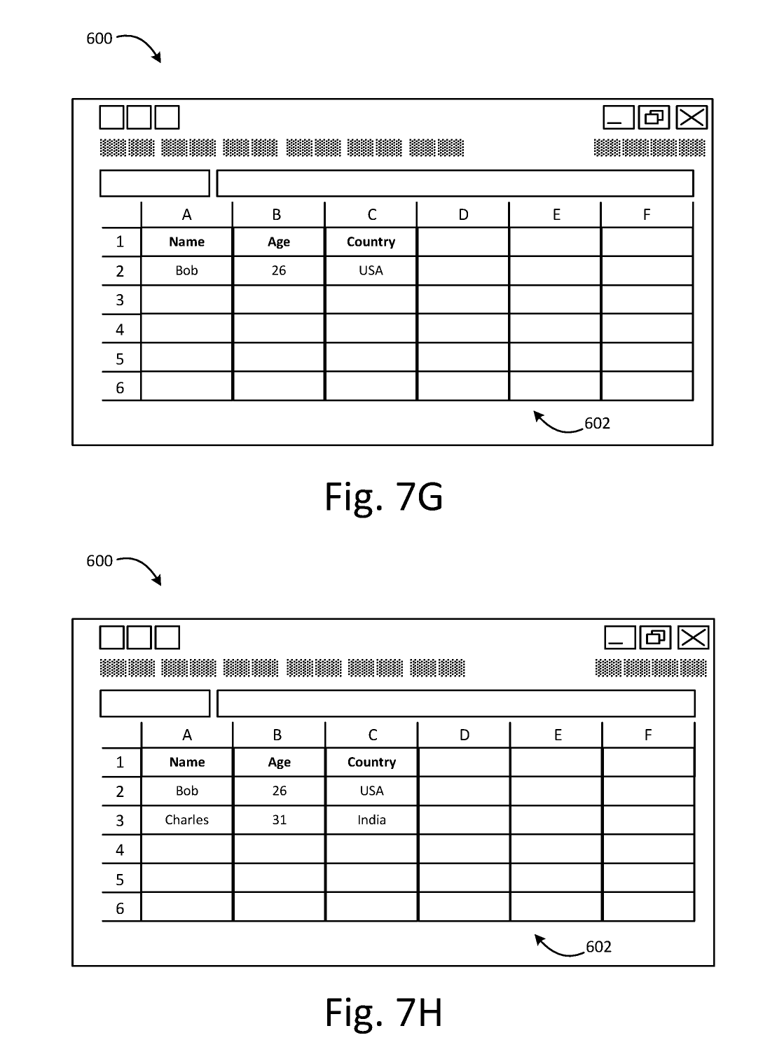

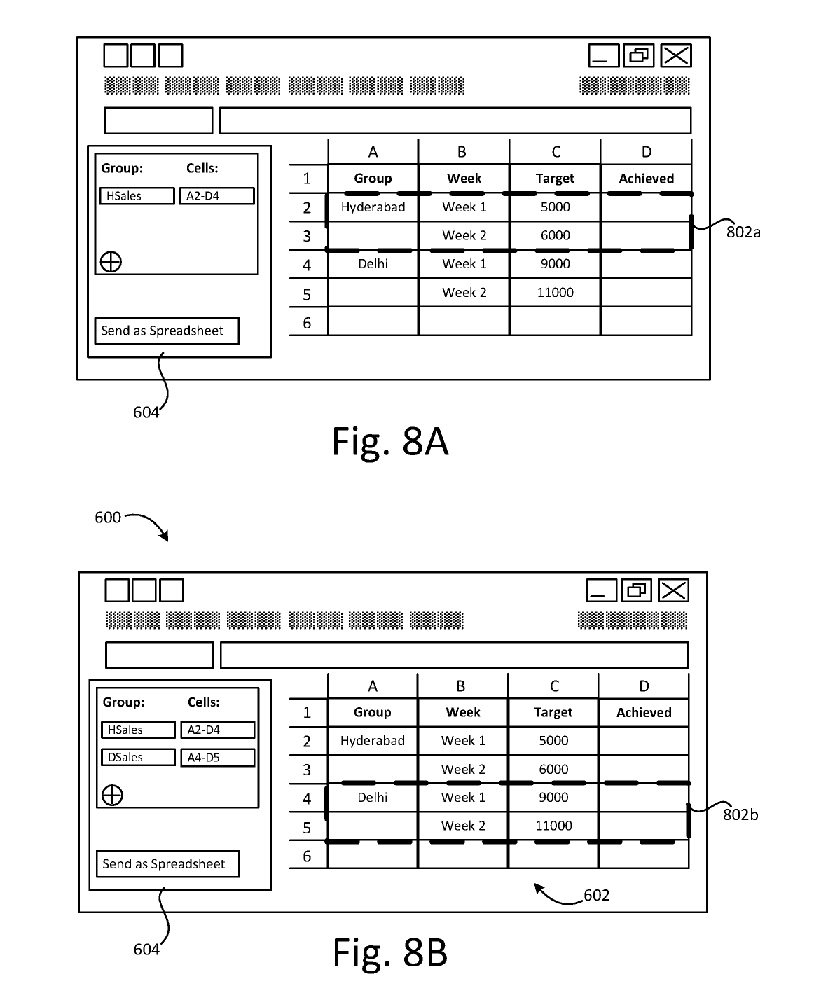

To aid illustration further, a specific example will now be described with reference to FIGS. 6 through 7H.

FIG. 6 shows an example of a user interface 600 provided by a conventional document editor for editing a spreadsheet. A two dimensional grid 602 is rendered as part of the interface 600 where each cell of the grid represents one cell of the spreadsheet being edited. Individual columns of the spreadsheet are identified by letters displayed along the top of the grid and individual rows are identified by numbers displayed down the left hand side of the grid 602. The initiating user 102 can input the initial information into the spreadsheet via the user interface 600 in the conventional manner which in this example consists of the text “name” in cell A1, “age” in cell B1 and “country” in cell C1. This text is recognised by the document editor as column headers for columns A, B and C respectively.

FIG. 7A shows how the conventional interface 600 of FIG. 6B can be extended to allow further information for populating the spreadsheet to be collected via the messaging system 100 in accordance with the techniques described herein. A menu 604 is shown displayed as part of the user interface 600 via which the user can select one or more messaging groups to receive the survey. The spreadsheet columns to use a basis for the questions in the survey can be selected from the grid 602 by the user manually or they can be selected automatically (although the user may be able to modify automatic selections if he wishes). In this example columns A through C are shown selected and the user has an option to send a survey based on those columns via the menu 604 to the selected group or groups. In this manner, the initiating user 102a provides an instruction to the database manager 212 to send the survey to the users in the selected group.

FIG. 7B shows the user device 104b of one of the recipient users after the survey has been sent by the initiating user 102a. The messaging interface for the group in question is shown on the display of the user device 104b such that the recipient user can see the sequence of messages transmitted and received in the chat between the members of that group. Within the sequence of messages, as part of the messaging interface, a survey request notification 702 is displayed, having a selectable option for the recipient user to respond to the survey sent by the initiating user 102a. As shown in FIGS. 7C through 7F, the recipient user, having selected this option, can respond to each of the survey questions in turn where each of those questions has been derived from one of the headers of the columns selected in FIG. 7A by the initiating user 102a. The questions are formulated as “what is your name?”, “what is your age?” and “what is your country?” for columns A, B and C respectively, as derived from the “name”, “age” and “country” text entered as column headers in columns A, B and C respectively. Intelligent processing can be performed by the database manager 212 to intelligently convert the header text into meaningful questions, e.g. using natural language processing. In this example the questions are presented one at a time on the display and the user inputs the answer to each question before selecting an option to move on to the next question, as shown in FIGS. 7C through 7E. He then has an opportunity once he has answered all the questions to review his answers, shown in FIG. 7F, before finally submitting them. However, as will be appreciated questions in a survey can be presented, and the answers to those questions collected, in any other suitable manner. By formulating the request as a series of survey questions, the recipient user is guided through the information collection process in a user-friendly manner. This can be particularly convenient for users that are uncomfortable entering information into a spreadsheet due to lack of familiarity or technical ability.

FIG. 7G shows the spreadsheet interface 600 once the spreadsheet has been automatically updated with the information provided by the recipient user 102b in completing the survey of FIGS. 7C to 7F. The users' answer to each question automatically is populated in a cell of the column from which that question was derived. In this example, cells can be assigned to the recipient users as they return their responses. Recipient user 102b is the first user to return his response in this example and is therefore assigned the cells in row 2 of the spreadsheet automatically. FIG. 7H shows the spreadsheet interface 600 at a later time when recipient user 102c has also completed the survey, with his answers also populated in cells of the corresponding columns. This user is the next user to return his response and is therefore assigned row 3 of the spreadsheet for his answers.

This can be extended in various ways.

For example, the table might have user phone numbers, or other user identifiers, that the DB manager 212 could use intelligently to send more targeted survey to users. In this case, cells are pre-assigned to the users and/or groups based on the user IDs in the spreadsheet. Some columns might have pre-filled information, which can then be converted into a more intelligent form targeted for the individual user in the group based on the phone number.

For example, a given user may not be asked questions for a column where the cell in that column assigned to him is already completed. Alternatively, he may be asked a question for that column but which is adapted for him based on the contents of that cell, e.g. to ask for more specific information. The provided information can then be merged appropriately with the existing information in the spreadsheet.

### EXAMPLE 2

Specific parts of a spreadsheet 222 (like Excel Tables) can be sent to particular users/groups using the messaging service 204 for easing data capture and co-authoring during business conversations on the network apps. Respective structural data, derived from the spreadsheet 222, is included in each information request to allow the relevant part of the spreadsheet to be re-constructed at the recipient device. The structural data denotes a structure of the relevant cells in the database, i.e. how they are laid-out within the rows/columns, so that they can be presented with a matching layout at the recipient device. For example, a supervisor could use this to share the daily/weekly sales targets in an Excel Table, which the sales team updates during the day/week as business conversations over network app. This data is updated in the original Excel Table, which the supervisor can use to monitor/report. This significantly reduces the level of manual effort required on the part of the supervisor.

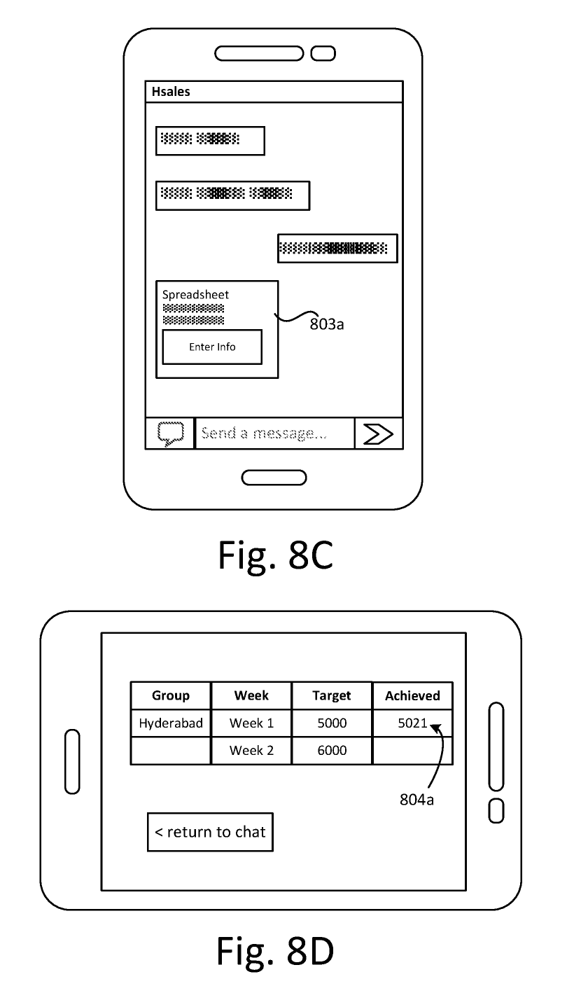

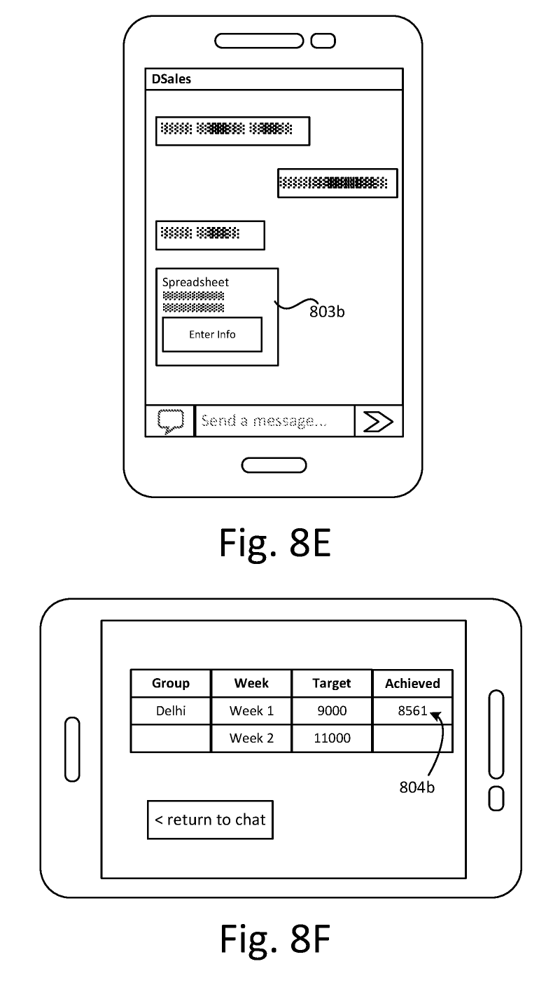

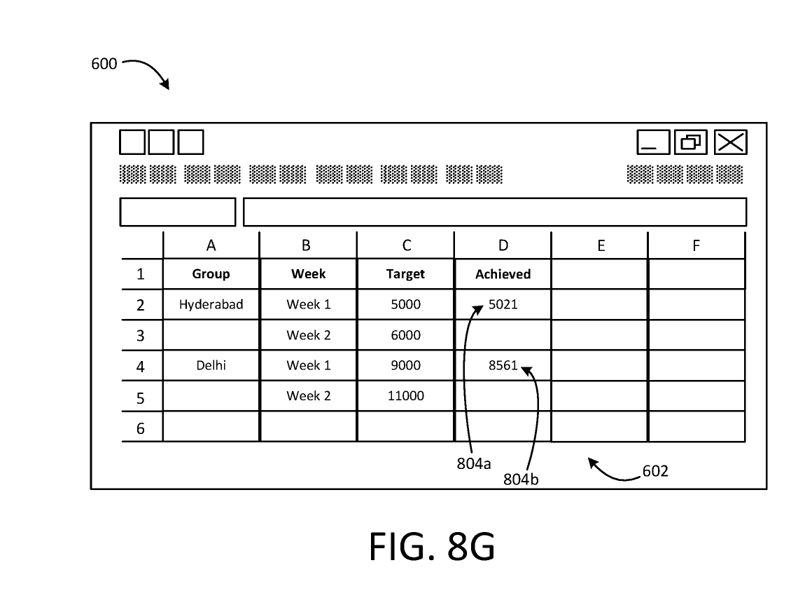

An example use case scenario is shown in FIGS. 8A through 8F, in which the initiating user 102a selects different parts of the spreadsheet (802a and 802b in FIGS. 8A and 8B respectively) to be sent to different messaging groups so that each of those groups can complete the respective part of the spreadsheet 802a and 802b that is sent to them. As shown in FIG. 8A, the first part of the spreadsheet 802a is selected to be sent to a first group and consists of cells A2 to D3. As shown in FIG. 8B, the second part of the spreadsheet 802b to be sent to a second user group is shown to consist of cells A4 to D5. Via the menu 604, in this example, the user can select which groups to send which parts of the spreadsheet to. Alternatively, these could be identified and suggested automatically by the system using information contained in the spreadsheet. In this example the spreadsheet contains location information which could be matched to location information associated with the user groups in order to automatically assign the corresponding parts of the spreadsheet to those user groups. The system can also automatically suggest which parts of the spreadsheet to send to which groups by analysing the content and structure of the spreadsheet. When the initiating user sends the spreadsheet, each user in each group is presented with a notification (803a and 803b in FIGS. 8C and 8E respectively) within the messaging interface for the chat for that user group. FIG. 8C shows the messaging interface for a user in the first group to which the first part of the spreadsheet 802a is sent. The notification 803a is shown within the sequence of messages for that group chat and has an option which is selectable to display the part of the spreadsheet assigned to that group. This is shown in FIG. 8D in which that part of the spreadsheet 802a is represented on the recipient user's device (and only that part of the spreadsheet) which that user is free to edit, in this example by entering a value, labelled 804a, into the cell corresponding to cell D2 in FIG. 8A. Column headers for columns A through D, taken from row 1 of the original spreadsheet, are also displayed to provide context to the recipient user and he may or may not be free to edit these. The representation of that part of the spreadsheet 804a is rendered using the structural data included in the information request sent to that device, to re-construct that part of the spreadsheet.

FIG. 8E shows the messaging interface for the second user group at the user device of one of the recipient users who is a member of the second group. In this example, selection of the notification 803b, within the chat interface for that group, renders the second part of the spreadsheet 802b available on the display of that device for editing, as shown in FIG. 8F. Again, that user is free to edit this part of the spreadsheet, and has done so in this example by entering a value in the cell corresponding to D4 in FIG. 8B where that value is labelled 804b in FIG. 8F. As can be seen, in this example, users in different groups are shown different parts of the spreadsheet and are only able to edit those parts of the spreadsheet that are assigned to them. They cannot edit parts of the spreadsheet that are assigned to others. As in FIG. 8D, the column headers are also displayed on the interface of FIG. 8F to provide context to the user in the second group.

FIG. 8G shows the original spreadsheet updated with the information 804a, 804b provided by both of the user groups. As can be seen, although each user group in this example can only edit part of the spreadsheet, the edits across the user groups are all merged into the original spreadsheet in order to provide updates across the original spreadsheet as a whole. This is particularly convenient in a scenario in which certain parts of the spreadsheet only apply to certain user groups as the recipient users only see information that is relevant to their own groups. This is particularly beneficial when their user devices have limited display area which is the case for smartphones and some tablet devices in particular. For such devices editing a whole spreadsheet would not be convenient. This approach also prevents users from inadvertently editing parts of the spreadsheet that are not applicable to them because they are only presented with the parts of the spreadsheet that are relevant.

Within the messaging system 100, each spreadsheet 222 can be identified by a global spreadsheet identifier, which could for example be derived from a file name of the spreadsheet and/or an identifier of a part of the spreadsheet assigned to the user or group in question, such as a deep link to that part of the spreadsheet. Each information request and response can include the spreadsheet identifier for the spreadsheet, and/or the identifier for the part of the spreadsheet, to which they relate so that the database manager 212 can keep track of which responses apply to which spreadsheet. Each information request 502 and response 502R can comprise an identifier of the user and/or the group to which it relates so that the database manager 212 can see which responses have come from which users/groups. Individual tables within a spreadsheet may be identified by table identifiers, which can be particularly useful where a spreadsheet contains multiple tables. In this case, where a request 502 or response 502R pertains to a particular table, it can include the table identifier in order to identify that table.

Although the above has been described in relation to a database in the form of an electronic spreadsheet, the invention can also be applied to other types of databases which may or may not be similarly embodied in a file. The term database is used herein to mean any structured set of data that is stored electronically in a computer readable format. Examples of databases embodied as files include for example Excel files, Comma Separated Values (CSV) files and other plain text databases etc. However the database need not be embodied in a file and can be implemented in some other manner.

Note references to software executed on at least one processor (or similar) can mean all of the software are executed on the same processor, or that portions of the code can be executed on different processors, which may or may not be co-located. For example, in the example architecture of FIGS. 1 to 2, the database manager 212, messaging service 204, authentication function 205 and intelligent services 220 described above can be individually implemented on one or multiple processors. In practice, different code portions may be implemented on different processors at different locations, possibly in different servers, possibly in data centres which can communicate via the network 108 or a dedicated back-end connection, for example. Note also that “computer storage” and “electronic storage” refer generally to one or more computer-readable storage devices, such as magnetic or solid-state storage devices. For multiple devices, they may or may not be spatially collocated. For example, different parts of the backend storage 146 may be implemented at different data centres, for example. The system code can be stored for execution at the system in question in one or more computer readable memory devices. The features of the techniques described herein are platform-independent, meaning that the techniques may be implemented on a variety of commercial computing platforms having a variety of processors. For example, the systems may include a computer-readable medium that may be configured to maintain instructions that cause the systems, and more particularly any operating system executed thereon and associated hardware of the system to perform operations. Thus, the instructions function to configure the operating system and associated hardware to perform the operations and in this way result in transformation of the operating system and associated hardware to perform functions. The instructions may be provided by the computer-readable medium to the system processor(s) through a variety of different configurations. One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method of populating a database with information provided by users of a messaging system, the messaging system for effecting instant messaging communication sessions in which users of the message system engage by sending and receiving messages via a network of the messaging system, the method comprising implementing, by an information manager, the following steps:
in response to an instruction received from an initiating one of the users, retrieving from the database initial information held in the database;
generating a plurality of information requests based on the initial information retrieved from the database;
sending each of the information requests to a recipient user via the network in an instant messaging communication session effected by the messaging system;
receiving a response to each of the information requests, wherein that response conveys at least one piece of information provided by the recipient user to which that message was sent;
assigning each of a plurality of fields of the database to one of the recipient users or to a group of the recipient users; and
populating each of the database fields with one of the pieces of information provided by the recipient user to which it is assigned or one of the group of recipient users to which it is assigned.

2. A method according to claim 1, wherein the database is an electronic spreadsheet.

3. A method according to claim 1, wherein each of the information requests comprises an identifier of a requested information type derived from the initial information by the information manager.

4. A method according to claim 3, wherein the database is an electronic spreadsheet, wherein the initial information comprises at least one column header of the electronic spreadsheet from which the identifier of the requested information type is derived.

5. A method according to claim 1, wherein each of the information requests is in the form of a survey having a series of questions derived from the initial information to be rendered at a user device operated by its recipient user.

6. A method according to claim 5, wherein the database is an electronic spreadsheet, wherein the initial information comprises multiple column headers of the spreadsheet and each of the questions is derived from one of the column headers.

7. A method according to claim 1, wherein the plurality of database fields are assigned to the recipient users or groups based on the responses received to the information requests.

8. A method according to claim 1, wherein the plurality of database fields are pre-assigned to the recipient users or groups before the responses are received.

9. A method according to claim 8, wherein the fields are pre-assigned by the information manager using the initial information in the database.

10. A method according to claim 8, wherein each of the information requests comprises structural data for rendering, at a user device operated by its recipient user, a representation of a set of the database fields pre-assigned to its recipient user or a group its recipient user is a member of, the structural data denoting a structure of that set of database fields within the database, wherein at least two of the recipient users or groups are pre-assigned different sets of database fields.

11. A method according to claim 1, wherein the information manager uses a first part of the initial information to generate a first of the information requests sent to a first of the recipient users, and a second part of the initial information to generate a second of the information requests sent to a second of the recipient users, whereby the first and second recipient users receive different information requests.

12. A method according to claim 11, wherein the information manager assigns a first set of fields of the database to the first recipient user or to a group the first recipient user is a member of, the first information request being generated based on that assignment, and assigns a second set of fields of the database to the second recipient user or to a group the second recipient user is a member of, the second information request being generated based on that assignment, whereby the first and second information requests are generated from different sets of database fields.

13. A method according to claim 12, wherein the first part of the initial information is retrieved from at least one of the first set of database fields and at least another of the first set of database fields is populated with the piece of information provided by the first recipient user, and the second part of the initial information is retrieved from at least one of the second set of database fields and at least another of the second set of database fields is populated with the piece of information provided by the second recipient user.

14. A method according to claim 13, wherein the first information request comprises first structural data denoting a structure of the first set of database fields within the database for rendering a representation of the first set of database fields at a user device operated by the first recipient user, and the second information request comprises second structural data denoting a structure of the second set of database fields within the database for rendering a representation of the second set of database fields at a user device operated by the second recipient user.

15. A method according to claim 1, wherein the information manager identifies at least one of the recipient users or groups automatically using the initial information in the database.

16. An information manager system for populating a database with information provided by users of a messaging system, the messaging system for effecting instant messaging communication sessions in which users of the message system engage by sending and receiving messages via a network of the messaging system, the information manager system comprising:
a network interface configured to connect to the network;
at least one processor; and
electronic storage coupled to the at least one processor and configured to hold computer-readable instructions, which are configured, when executed on the at least one processor, to implement the following steps:
in response to an instruction received from an initiating one of the users, retrieving from the database initial information held in the database,
generating a plurality of information requests based on the initial information retrieved from the database,
sending each of the information requests to a recipient user via the network in an instant messaging communication session effected by the messaging system,
receiving a response to each of the information requests, wherein that response conveys at least one piece of information provided by the recipient user to which that message was sent,
assigning each of a plurality of fields of the database to one of the recipient users or to a group of the recipient users, and
populating each of the database fields with one of the pieces of information provided by the recipient user to which it is assigned or one of the group of recipient users to which it is assigned.

17. A system according to claim 16, wherein the database is an electronic spreadsheet.

18. A system according to claim 16, wherein each of the information requests comprises an identifier of a requested information type derived from the initial information by the information manager.

19. A system according to claims 18, wherein the database is an electronic spreadsheet, wherein the initial information comprises at least one column header of the electronic spreadsheet from which the identifier of the requested information type is derived.

20. A computer program product for populating a database with information provided by users of a messaging system, the messaging system for effecting instant messaging communication sessions in which users of the message system engage by sending and receiving messages via a network of the messaging system, the computer program product comprising computer-readable instructions stored on a computer-readable storage medium and configured, when executed, to implement the following steps:
in response to an instruction received from an initiating one of the users, retrieving from the database initial information held in the database;
generating a plurality of information requests based on the initial information retrieved from the database;
sending each of the information requests to a recipient user via the network in an instant messaging communication session effected by the messaging system;
receiving a response to each of the information requests, wherein that response conveys at least one piece of information provided by the recipient user to which that message was sent;
assigning each of a plurality of fields of the database to one of the recipient users or to a group of the recipient users; and
populating each of the database fields with one of the pieces of information provided by the recipient user to which it is assigned or one of the group of recipient users to which it is assigned.
